(19) United States
(12) Patent Application Publication
(10) Pub. No.: US 2024/0344363 A1
(43) Pub. Date: Oct. 17, 2024

(54) MULTI-DIRECTIONAL LOCK, LUGGAGE WITH SAME, AND CABINET WITH THE MULTI-DIRECTIONAL LOCK

(71) Applicant: SINOX COMPANY LTD., New Taipei City (TW)

(72) Inventor: Chia-Hsuan HU, New Taipei City (TW)

(73) Assignee: SINOX COMPANY LTD., New Taipei City (TW)

(21) Appl. No.: 18/630,223

(22) Filed: Apr. 9, 2024

(30) Foreign Application Priority Data
Apr. 12, 2023 (TW) 112113680

(51) Int. Cl. E05B 63/14; E05B 65/52

(52) U.S. Cl. CPC E05B 63/143; E05B 65/5269

(57) ABSTRACT

A multi-directional lock has a base seat, at least three buckles, at least three fastener assemblies, a displacement operating unit, and a fixing unit. When the multi-directional lock is to be unlocked, firstly, the fixing unit is released from the displacement operating unit, then the user can push the displacement operating unit towards the to-be-unlocked buckle, and the buckle will be switched to the fastener unlocked state, so that the fastener can be withdrawn. The multi-directional lock controls that the fasteners of multiple buckles can be pulled out by different movements of a single element, and the user only needs to unlock or operate to unfasten the displacement operating unit. The user can choose which fastener of the buckle to be pulled out by moving the displacement operating unit.

### BACKGROUND OF THE INVENTION

### 1. Field of the Invention

The present invention relates to a multi-directional lock, especially to a multi-directional lock for luggage.

### 2. Description of the Prior Arts

A conventional lock often requires a push button to be unlocked (by a physical key or a combination code), e.g., after the push button is pushed, a fastener (plug) can be pulled out.

However, the push buttons of the conventional locks can only be used to unlock the mechanism at one site, for example, to enable only one fastener to be withdrawn, or to enable a number of fasteners at the same site to be withdrawn. In other words, if there is a need to lock different sites, for example, if there are fasteners at different sites, it is often necessary to separately set up multiple locks to control, such as inserting a key at two different sites and rotating the key in order to allow the fasteners at two different sites to be pulled out, which is inconvenient for the use of the locks.

To overcome the shortcomings, the present invention provides a multi-directional lock, a luggage with the lock, and a cabinet with the lock to mitigate or obviate the aforementioned problems.

### SUMMARY OF THE INVENTION

The main objective of the present invention is to provide a multi-directional lock, a luggage with the lock, and a cabinet with the lock. The multi-directional lock is applicable to unlock the fasteners in different positions, so that the unlocking process only needs to be done once to allow the fasteners in different positions to be pulled out, and the luggage and the multi-directional lock are convenient to use.

The multi-directional lock includes a base seat, at least three buckles, at least three fastener assemblies, a displacement operating unit, and a fixing unit. The at least three buckles are mounted on the base seat and spaced apart from each other. Each one of the buckles has a fastener locked state and a fastener unlocked state. The at least three fastener assemblies are respectively inserted in the at least three buckles. When each one of the buckles is in the fastener unlocked state, the fastener assembly inserted in the buckle is detachable from the buckle. The at least three fastener assemblies respectively correspond to the opening parts of the luggage body. After the fastener assembly is separated from the corresponding buckle, the corresponding opening part is openable. The displacement operating unit is movably mounted on the base seat. The displacement operating unit comprises multiple movement paths relative to the base seat, and each one of the movement paths corresponds to one of the buckles. When the displacement operating unit is moved along one of the movement paths, the buckle corresponding to the movement path is capable of switching to the fastener unlocked state. The fixing unit prevents the displacement operating unit from moving relative to the base seat toward any of the buckles.

The luggage includes a luggage body and an aforementioned multi-directional lock. The luggage body comprises multiple opening parts. The at least three fastener assemblies respectively correspond to the multiple opening parts of the luggage body. After one of the at least three fastener assemblies is separated from the corresponding buckle, the corresponding opening part is openable.

The cabinet includes multiple cabinet doors and an aforementioned multi-directional lock. The at least three fastener assemblies are respectively connected to the multiple cabinet doors. After one of the at least three fastener assemblies is separated from the corresponding buckle, the corresponding cabinet door is openable.

When the multi-directional lock is to be unlocked, firstly, the fixing unit is released from the displacement operating unit. Then, the user can push the displacement operating unit along a specific movement path, and the displacement operating unit switches the buckle, which corresponds to the movement path, to the fastener unlocked state, so that the fastener of the buckle can be withdrawn, while the fastener of the other buckles still stops the fasteners from being withdrawn.

The multi-directional lock controls that the fasteners of multiple buckles can be pulled out by different movements of a single element (displacement operating unit), and the user only needs to unlock or operate once to unfasten the displacement operating unit. The user can choose which fastener of the buckle to be pulled out by moving the displacement operating unit. Afterwards, the user can move the displacement operating unit several times in sequence to pull out all the fasteners of the buckles. In short, the user only needs to carry out unlocking or operation of the fixing unit once.

In other words, in the embodiment where the fixing unit is a lock, it is convenient to insert a key or enter a code only once to enable any of the fastener of the buckle, or to enable all of the fasteners of the buckles to be withdrawn.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a multi-directional lock in accordance with a first embodiment of the present invention;

FIG. 2 to FIG. 4 are exploded views of the multi-directional lock in FIG. 1;

FIG. 5 and FIG. 6 are operational views of a key lock of the multi-directional lock in FIG. 1;

FIG. 7 and FIG. 8 are operational views of a combination lock of the multi-directional lock in FIG. 1;

FIG. 9 and FIG. 10 are exploded views of the multi-directional lock in FIG. 1;

FIG. 11 is a schematic view of locking a fastener of the multi-directional lock in FIG. 1;

FIG. 12 is a schematic view of unlocking the fastener of the multi-directional lock in FIG. 1;

FIG. 13 and FIG. 14 are exploded views of the multi-directional lock in FIG. 1;

FIG. 15 and FIG. 16 are operational cross-sectional side views of the multi-directional lock in FIG. 1;

FIG. 17 is a perspective view of a multi-directional lock in accordance with a second embodiment;

FIG. 18 is a schematic view of a piece of luggage in FIG. 1; and

FIG. 19 is a schematic view of a cabinet in accordance with the present invention.

### DETAILED DESCRIPTION OF THE PREFERRED EMBODIMENTS

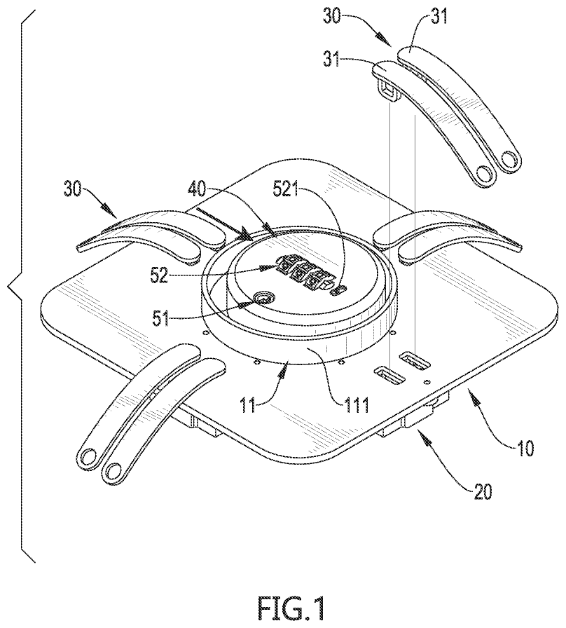

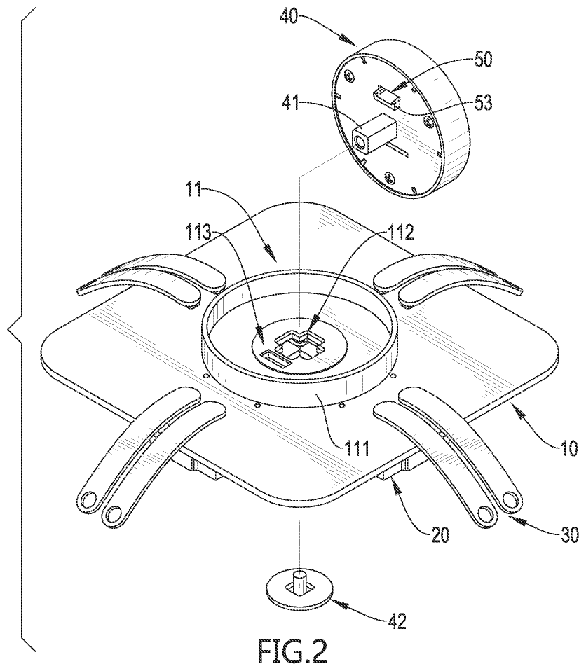

With reference to FIG. 1 and FIG. 2, a multi-directional lock in accordance with the present invention comprises a base seat 10, at least three buckles 20, at least three fastener assemblies 30, a displacement operating unit 40 and a fixing unit 50. In this embodiment, the quantity of the buckles 20 is four, the quantity of the fastener assemblies 30 is also four, but the quantities are not limited. The quantity of the buckles 20 and the fastener assemblies 30 can also be five, six, eight, or other quantities.

The aforementioned buckles 20 are mounted on the base seat 10 and spaced apart from each other. The buckles 20 are preferably arranged spaced apart around the displacement operating unit 40, and are preferably arranged at equiangular intervals. Therefore, the four buckles in this embodiment are arranged at 90 degrees intervals, but it is not limited thereto, the buckles 20 may be in a non-annular arrangement but may even be arranged in a straight line, and so on. Each one of the buckles 20 has a fastener locked state and a fastener unlocked state.

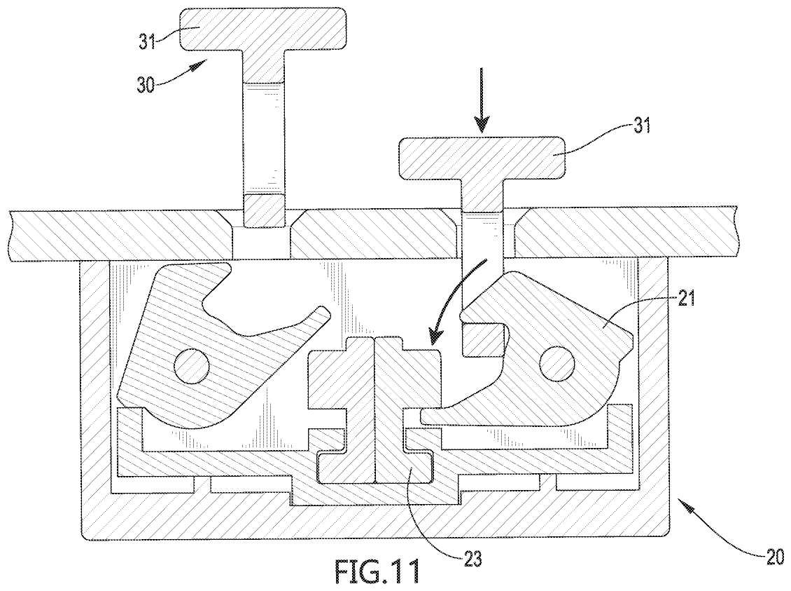

With reference to FIG. 1, FIG. 2 and FIG. 11, the aforementioned fastener assemblies 30 are respectively inserted into the buckles 20, and the quantity of the fastener assemblies 30 and the quantity of the buckles 20 are equal. When each one of the buckles 20 is in the fastener locked state, the buckle 20 prevents the fastener assembly 30 inserted in the buckle 20 from being detachable from the buckle 20. When each one of the buckles 20 is in the fastener unlocked state, the fastener assembly 30 inserted in the buckle 20 can be detached from the buckle 20.

Preferably, after each one of the fastener assemblies 30 is inserted into the corresponding buckle 20, the buckle 20 will be in the fastener locked state, but it is not limited thereto, as the buckle 20 can also be brought into the fastener locked state by other means.

In this embodiment, each one of fastener assemblies 30 includes two fasteners 31, but each one of fastener assemblies 30 may also comprise only one fastener 31 or the fasteners may be in other quantities.

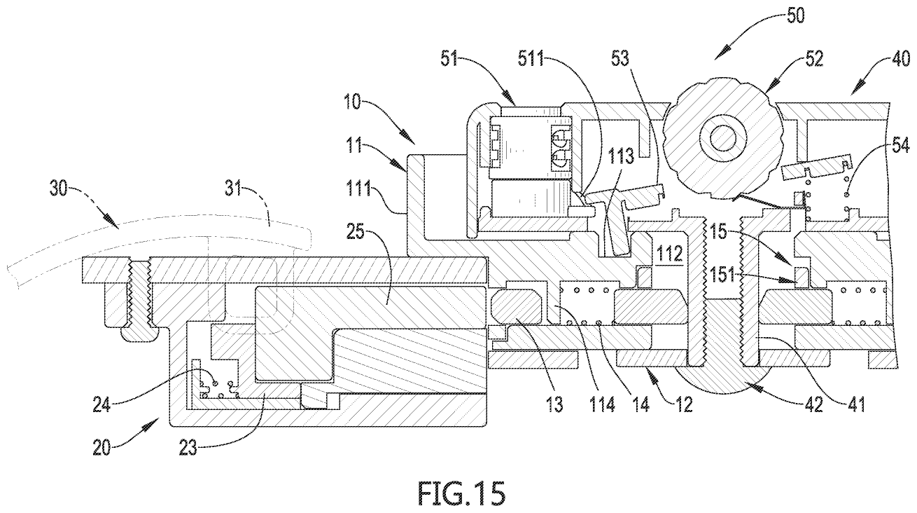

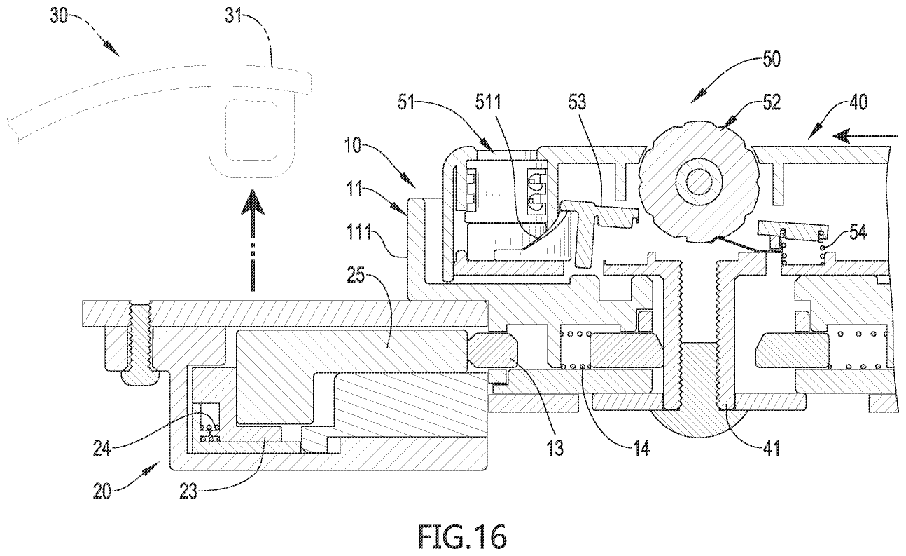

With reference to FIG. 1, FIG. 2, FIG. 15 and FIG. 16, the aforementioned displacement operating unit 40 is movably mounted on the base seat 10. The displacement operating unit 40 comprises multiple movement paths relative to the base seat 10, and each one of the movement paths corresponds to one of the buckles 20. The movement path can be straight or curved in various shapes. When the displacement operating unit 40 moves along one of the movement paths, the buckle 20 corresponding to the movement path is switched into the fastener unlocked state, so that the fastener assembly 30 inserted in the buckle 20 can be separated.

In this embodiment, when the displacement operating unit 40 is moved toward one of the buckles 20 to switch the buckle 20 to the fastener unlocked state, the buckle 20 will push the corresponding fastener assembly 30 out of the buckle 20, but it is not limited thereto, as the fastener assembly 30 can also be withdrawn manually.

In this embodiment, the movement path of the displacement operating unit 40 is directed toward or away from the corresponding buckle 20. In other words, in the embodiment where the movement path is straight, the corresponding buckle 20 is located on an extension line of the movement path, but it is not limited thereto. In this embodiment, the movement path of the displacement operating unit 40 is a straight line and toward the corresponding buckle 20, that is, the buckle 20 that the displacement operating unit 40 moves toward will be unlocked, and such an operation is the most intuitive way.

In this embodiment, the multi-directional lock further includes a limit device mounted between the displacement operating unit 40 and the base seat 10. The limit device restricts the movement of the displacement operating unit 40 back to an origin before moving toward another buckle 20. Therefore, even if the buckles 20 are not far apart, the neighboring buckles 20 will not inadvertently unlock after unlocking one of the buckles 20. In this embodiment, the origin is the center of the base seat 10, but it is not limited thereto.

In this embodiment, the limit device restricts the movement paths of the displacement operating unit 40 to multiple straight lines extending from the original position, and in the embodiment of the four buckles 20, the four straight lines are connected to form a cross.

In this embodiment, the multi-directional lock further includes a reset device mounted between the displacement operating unit 40 and the base seat 10, and tend to move the displacement operating unit 40 to the origin. Therefore, after the user has moved and released the displacement operating unit 40, the displacement operating unit 40 will automatically move back to the origin.

In this embodiment, the multi-directional lock further includes an anti-rotation device mounted between the displacement operating unit 40 and the base seat 10, and prevents the displacement operating unit 40 from rotating relative to the base seat 10. Therefore, the displacement operating unit 40 can only be moved but not rotated, but it is not limited thereto. The multi-directional lock can also be designed that the displacement operating unit 40 can rotate freely relative to the base 10.

With reference to FIG. 2, FIG. 15 and FIG. 16, the aforementioned fixing unit 50 prevents the displacement operating unit 40 from moving relative to the base seat 10 toward any of the buckles 20, which means that the multi-directional lock cannot be unlocked.

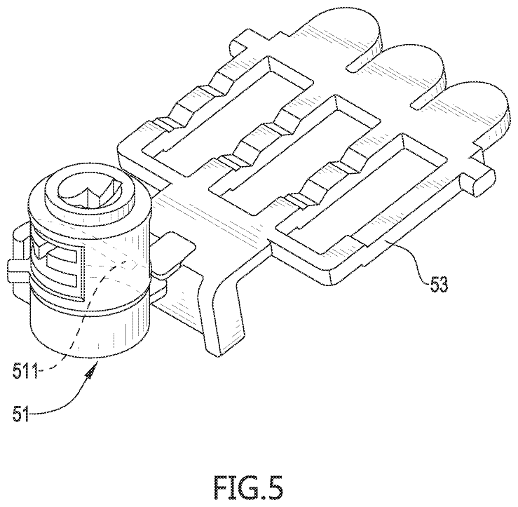

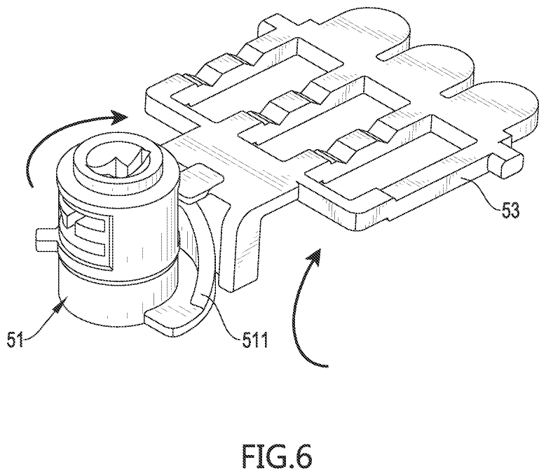

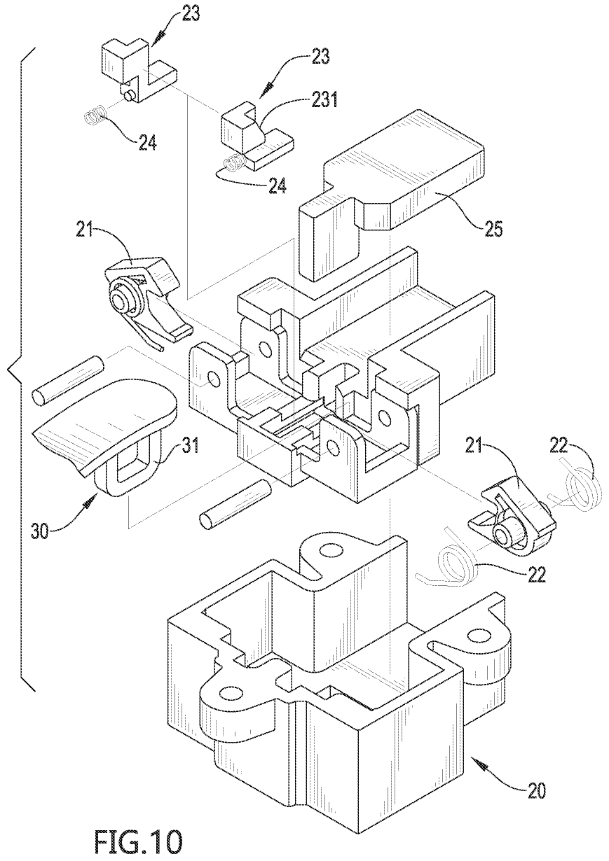

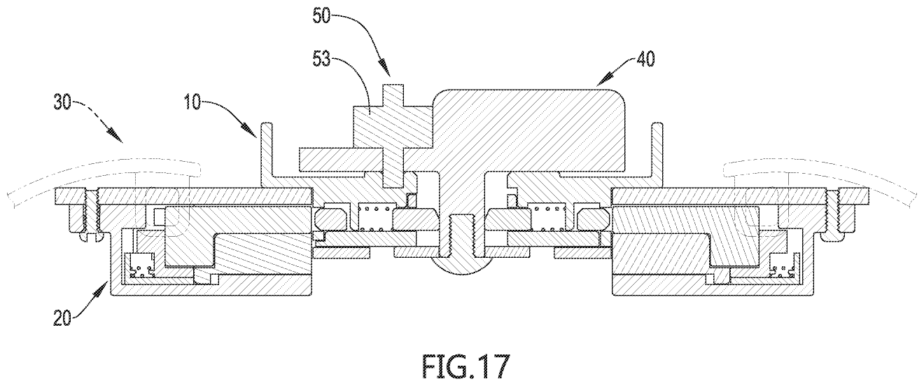

The fixing unit 50 may include at least one lock, for example, in the first embodiment of the present invention (FIG. 1 to FIG. 16), when the lock is not unlocked, the fixing unit 50 prevents the displacement member 40 from moving, and thus prevents the unlocking of any of the buckles 20. The fixing unit 50 may also not comprise a lock, but the fixing unit 50 may be freely operable to control whether the displacement operating unit 40 can be moved or not, such as in the second embodiment of the present invention (FIG. 17). With reference to FIG. 17, the fixing unit 50 is in the configuration of a pin that penetrates through the displacement operating unit 40 and is inserted into the base seat 10 so that the displacement operating unit 40 cannot be moved, but the configuration of the fixing unit 50 is not limited to this.

With reference to FIG. 2, FIG. 15 and FIG. 16, in this embodiment, the fixing unit 50 is mounted on the displacement operating unit 40, the fixing unit 50 can be securely or detachably mounted on the displacement operating unit 40. The fixing unit 50 comprises an insertion part 53 that can be inserted in the base seat 10 to prevent the displacement operating unit 40 from moving relative to the base seat 10 toward any of the buckles 20, but it is not limited thereto. For example, the fixing unit 50 may also be inserted into the displacement operating unit 40 from the base seat 10 to prevent the displacement operating unit 40 from moving. The configuration of the fixing unit 50 is not limited and can be varied, as long as the fixing unit 50 prevents the displacement operating unit 40 from moving against the base seat 10 toward any of the buckles 20.

In the first embodiment, the fixing unit 50 includes multiple locks, and any one of the locks can be unlocked to release the fixing unit 50 from the displacement of the displacement operating unit 40, so that the user can choose any way to release the displacement of the displacement operating unit 40, but it is not limited thereto. The fixing unit 50 can be changed so that all locks are unlocked before the displacement operating unit 40 is released.

The following is a specific embodiment of how to accomplish the foregoing, but this present invention is not limited to this specific embodiment.

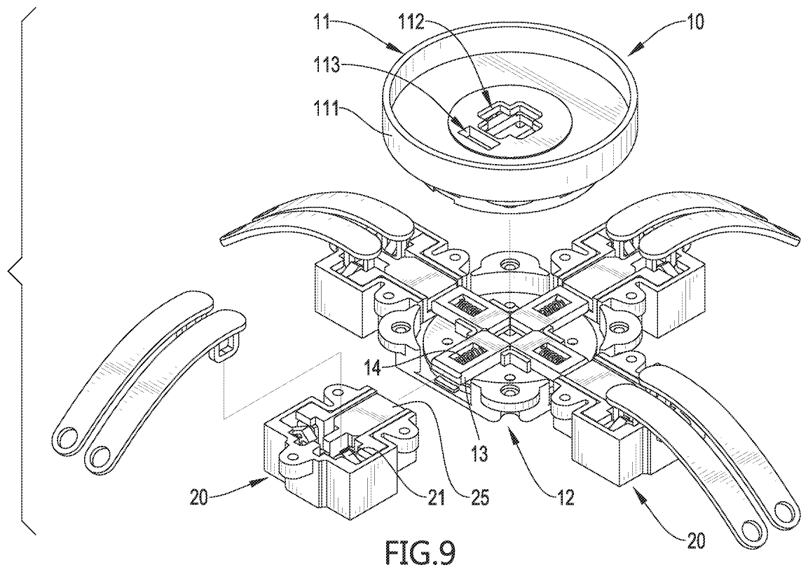

With reference to FIG. 2, FIG. 9 and FIG. 15, the base seat 10 comprises an accommodating part 11 to accommodate the displacement operating unit 40.

The accommodating part 11 and the displacement operating unit 40 are corresponding to each other in shape and preferably both are circular. The accommodating part 11 comprises a limit wall 111 surrounding the displacement operating unit 40. The accommodating part 11 comprises the track hole 112 of the movement path of the corresponding displacement operating unit 40. The displacement operating unit 40 comprises a block 41 mounted through the track hole 112, so that the displacement operating unit 40 can only move along the specific movement path, and the track hole 112 and the block 41 are an embodiment of a limit device. The block 41 of the displacement operating unit 40 penetrates through the base seat 10 and is coupled with a clamp unit 42, so that the displacement operating unit 40 cannot be discretely detached from the base seat 10. The accommodating part 11 comprises a clamp slot 113 for insertion of the insertion part 53 of the fixing unit 50 into the clamp slot 113.

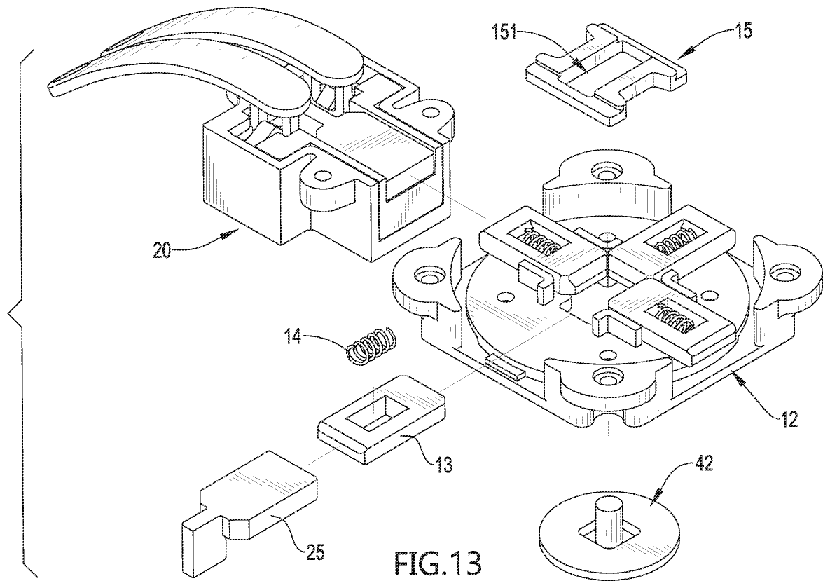

With reference to FIG. 13 to FIG. 15, the base seat 10 comprises an anti-rotation unit 15 movably mounted on the accommodating part 11, and the anti-rotation unit 15 comprises an elongated hole 151 configured to penetrate through the block 41 of the displacement operating unit 40. The elongated hole 151 and the block 41 of the displacement operating unit 40 are corresponding to each other in shape, so that the block 41 can move along the elongated hole 151 but cannot rotate relative to the anti-rotation unit 15, the accommodating part 11 and the whole base seat 10. An embodiment of the anti-rotation device is formed by the anti-rotation unit 15 and the block 41.

The movement direction of the anti-rotation unit 15 relative to the accommodating part 11 is parallel to one of the movement paths (or two movement paths opposite to each other) of the displacement operating unit 40, such that when the displacement operating unit 40 moves along the aforementioned movement path, the anti-rotation unit 15 is moved together (via the block 41).

The extending direction of the elongated hole 151 is parallel to one of the movement paths (or two movement paths opposite to each other) of the displacement operating unit 40, such that when the displacement operating unit 40 moves along the aforementioned movement path, the anti-rotation unit 15 does not move along with the displacement operating unit 40.

The movement path corresponding to the elongated hole 151 is different from the movement path corresponding to the anti-rotation unit 15. In this embodiment, there are four movement paths, the elongated hole 151 corresponds to two of the opposite movement paths, the anti-rotation unit 15 moves to the other two opposite moving paths, so that the displacement operating unit 40 can move along the four moving paths without being obstructed.

With reference to FIG. 2 to FIG. 4, the fixing unit 50 of the first embodiment includes two locks, and each one of the locks retracts the insertion part 53 away from the clamp slot 113 of the accommodating part 11. The insertion part 53 is a bent plate and comprises an insertion flexible unit 54 to keep the insertion part 53 out of the fixing unit 50. The two locks are preferably a key lock 51 and a combination lock 52.

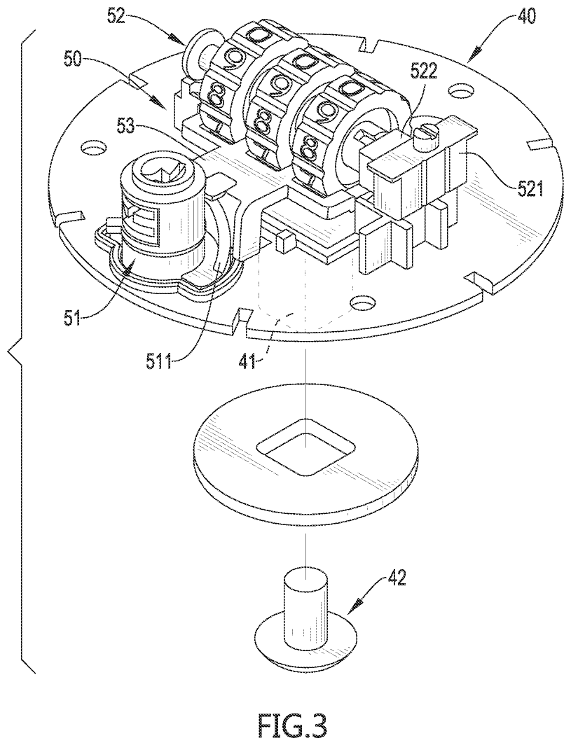

With reference to FIG. 3 to FIG. 6, the key lock 51 comprises an abutting incline 511 abutting the insertion part 53. After a key is inserted into the key lock 51 and rotated, the abutting incline 511 will follow the rotation and push the insertion part 53 away from the clamp slot 113 (i.e., retract the insertion part 53).

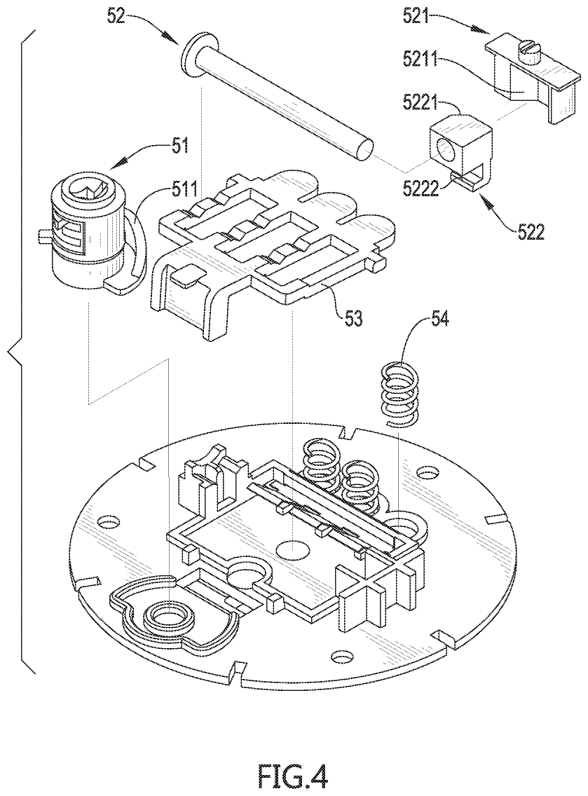

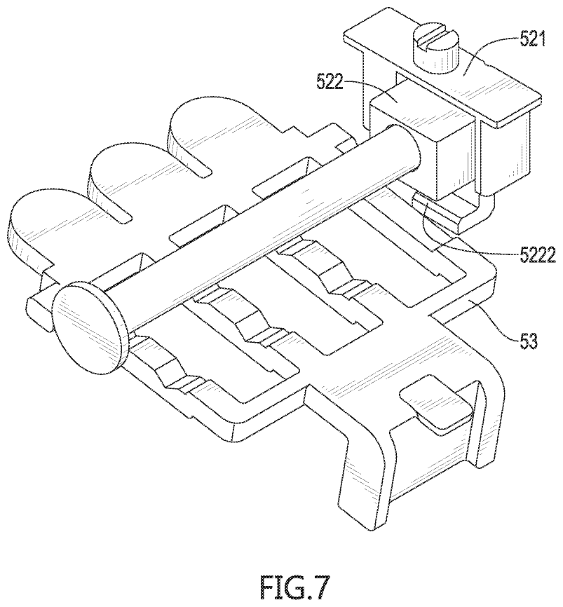

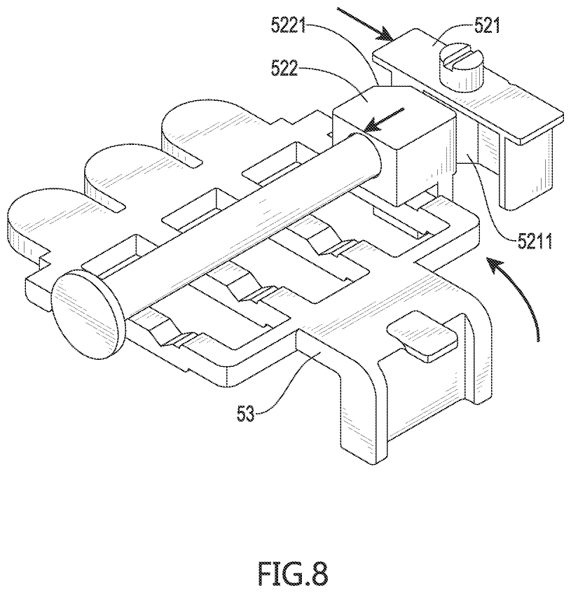

With reference to FIG. 3, FIG. 4, FIG. 7 and FIG. 8, the combination lock 52 includes an operating unit 521 (preferably a pushing button) and an abutting unit 522. When entering the correct combination code, the user can operate the exposed operating unit 521, the operating unit 521 will actuate the abutting unit 522 (preferably through the incline 5211 of the operating unit 521 and the first incline 5221 of the abutting unit 522), and the abutting unit 522 will actuate against the insertion part 53 (preferably through the second incline 5222 of the abutting unit 522) and push the insertion part 53 out of the clamp slot 113 (i.e., to retract the insertion part 53).

Next is the portion of the displacement operating unit 40 that unlocks the buckle 20.

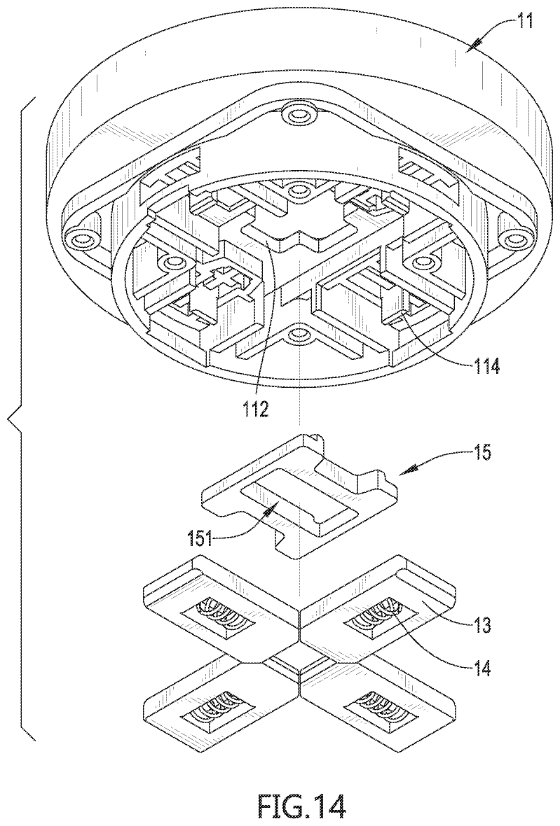

With reference to FIG. 9, FIG. 13 and FIG. 14, the base seat 10 comprises a bottom base 12, at least three push-in units 13 and at least three push-in flexible components 14. The quantity of the push-in units 13 and the quantity of the push-in flexible components 14 are as same as the quantity of the buckles 20. The push-in unit 13 is movably mounted on the bottom base 12, and when the displacement operating unit 40 is moved, the displacement operating unit 40 (preferably via the block 41) pushes the corresponding push-in unit 13, causing the push-in unit 13 to move toward the corresponding buckle 20. The push-in flexible component 14 is configured to move the corresponding push-in unit 13 back to the origin together with the displacement operating unit 40 (block 41), and all push-in flexible components 14 form an embodiment of a reset device. Preferably, the two ends of the push-in flexible component 14 respectively abut the push-in unit 13 and the push-in column 114 of the accommodating part 11 (as shown in FIG. 14).

With reference to FIG. 9 to FIG. 11, the buckle 20 includes at least one clasp 21, at least one clasp flexible unit 22, at least one lock device 23, at least one lock device flexible unit 24 and a releasing unit 25. The quantity of the clasp 21, the quantity of the clasp flexible unit 22, the quantity of the lock device 23, and the quantity of the fastener 31 of the fastener assembly 30 are the same. The clasp 21 is rotatably (or movably) mounted in the buckle 20, and the fastener 31 will rotate (or move) the clasp 21 after inserted into the buckle 20. After the clasp 21 pushes away from the lock device 23 (preferably through the incline 231 of the lock device 23) and passes through the lock device 23, the lock device flexible unit 24 returns the lock device 23 to the original position and prevents the clasp 21 from rotating (or moving) back to the original position, and the clasp 21 also prevents the fastener 31 from detaching from the buckle 20.

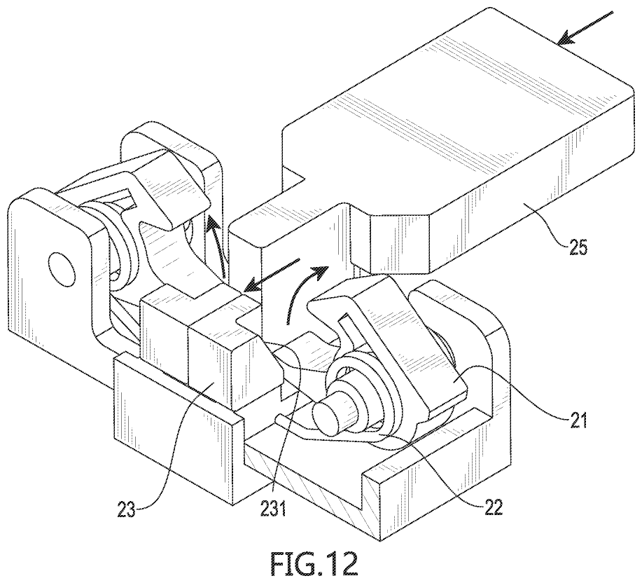

With reference to FIG. 12, FIG. 15 and FIG. 16, when the displacement operating unit 40 moves and pushes the corresponding push-in unit 13 toward one of the buckles 20, the push-in unit 13 pushes the releasing unit 25 of the buckle 20. The releasing unit 25 pushes all of the lock devices 23 at the same time so that the lock device 23 no longer blocks the clasp 21, and the clasp flexible unit 22 rotates (or moves) the clasp 21 back to the original positions. The fastener 31 will be pushed out of the buckle 20.

With reference to FIG. 15 and FIG. 16, when the present invention is to be unlocked, firstly, the fixing unit 50 is released from the displacement operating unit 40 (the first embodiment is to unlock the key lock 51 or the combination lock 52 so that the insertion part 53 is retracted, and the second embodiment is to pull out the fixing unit 50 in the configuration of a pin), and then the user can push the displacement operating unit 40 towards the to-be-unlocked buckle 20, and the buckle 20 will be switched to the fastener unlocked state, and the two fastener 31 of the fastener assembly 30 will be ejected from the buckle 20.

Then, after the displacement operation component 40 is moved back to the origin, it can be moved towards the other to-be-unlocked buckle 20.

The multi-directional lock controls that the fasteners 31 of the multiple buckles 20 can be pulled out by different movements of a single element (displacement operating unit 40), and the user only needs to unlock (key lock 51 or combination lock 52) or operate (pulling out the pins) to unfasten the displacement operating unit 40. The user can choose which fastener 31 of the buckle 20 to be pulled out by moving the displacement operating unit 40. Afterwards, the user can move the displacement operating unit 40 several times in sequence to pull out all the fasteners 31 of the buckle 20; in short, the user only needs to carry out unlocking or operation of the fixing unit 50 once, and thus it is convenient to use.

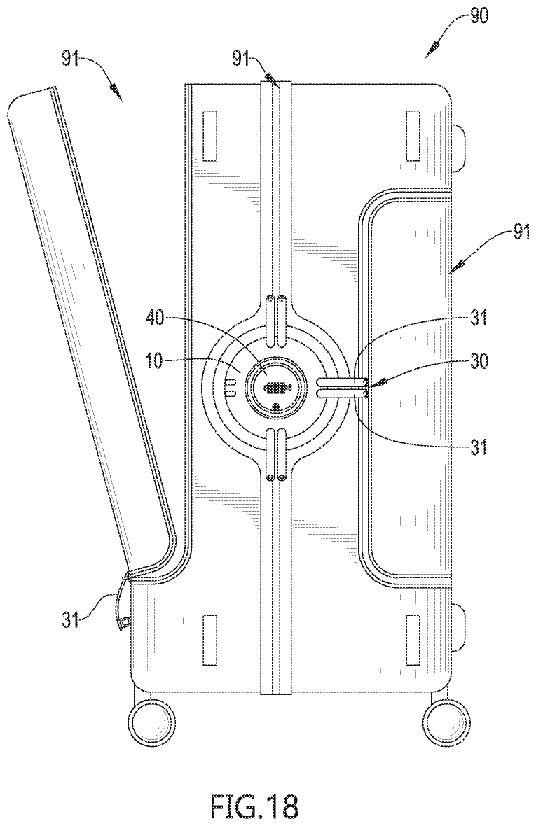

With reference to FIG. 18, a piece of luggage in accordance with the present invention includes a luggage body 90 and an aforementioned multi-directional lock.

The luggage body 90 comprises multiple opening parts 91. The luggage body 90 is preferably a suitcase, but can also be a backpack, a handbag, a briefcase, and other types of bags that can carry personal belongings for easy transportation.

The multiple fastener assemblies 30 of the multi-directional lock respectively correspond to the multiple opening parts 91 of the luggage body 90. When the fastener assembly 30 is disengaged from the corresponding buckle 20, the corresponding opening part 91 can be opened. The fastener assembly 30 and the opening part 91 may not be in one-to-one correspondence; in this embodiment, the luggage body 90 comprises three opening parts 91. The three opening parts 91 are respectively the main openings of the side flaps on both sides and the middle. Among the four fastener assemblies 30, the two fastener assemblies 30 respectively correspond to the zippers of the side flaps on both sides, and the top and bottom fastener assemblies 30 correspond to the zippers of the main opening in the middle. However, the configuration of the luggage and the fastener assembly 30 are not limited in this way; for example, the fastener assembly 30 does not necessarily have to be applied to the zipper, but only has to be that when the fastener assembly 30 is not disengaged from the buckle 20, the fastener assembly 30 cannot make the opening part 91 openable.

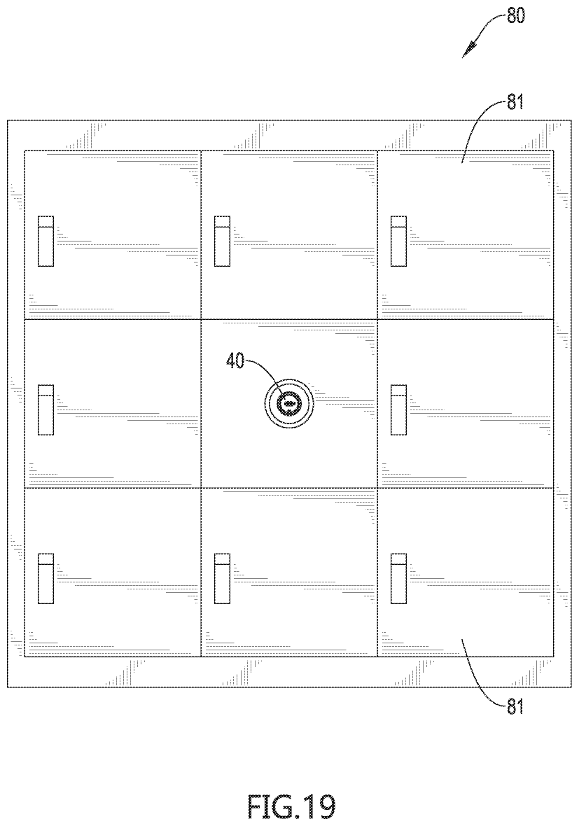

The multi-directional lock can also be used in a box or a cabinet. With reference to FIG. 19, the multi-directional lock can be used in a cabinet 80, and each fastener assembly is connected to one of the cabinet doors 81, so when the buckle 20 is in the fastener unlocked state, the fastener assembly can be disengaged from the buckle, then the cabinet door 81 connected to the fastener assembly can be opened. The user can move the displacement operating unit 40 by unlocking the displacement operating unit 40 (e.g., by entering a correct combination code) so that the cabinet door 81 in that direction can be opened.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A multi-directional lock comprising:
a base seat;
at least three buckles mounted on the base seat and spaced apart from each other; each one of the at least three buckles having a fastener locked state and a fastener unlocked state;
at least three fastener assemblies, respectively inserted in the at least three buckles; the fastener assembly inserted in said buckle being detachable from said buckle when each one of the at least three buckles is in the fastener unlocked state;
a displacement operating unit movably mounted on the base seat; the displacement operating unit having
multiple movement paths relative to the base seat; each one of the movement paths corresponding to one of the at least three buckles; the buckle corresponding to the movement path switched to the fastener unlocked state when the displacement operating unit moves along one of the movement paths;
a fixing unit stopping the displacement operating unit from moving relative to the base seat toward any of the at least three buckles.

2. The multi-directional lock as claimed in claim 1, wherein each one of the movement paths of the displacement operating unit is toward or away from the corresponding buckle.

3. The multi-directional lock as claimed in claim 1 further including
a limit device mounted between the displacement operating unit and the base seat, and restricting the displacement operating unit that needs to restore back to an origin before moving toward another one of the at least three buckles.

4. The multi-directional lock as claimed in claim 2, further including
a limit device mounted between the displacement operating unit and the base seat, and restricting the displacement operating unit that needs to restore back to an origin before moving toward another one of the at least three buckles.

5. The multi-directional lock as claimed in claim 3, wherein the limit device limits each one of the movement paths of the displacement operating unit to be a straight line extending from the origin.

6. The multi-directional lock as claimed in claim 4, wherein the limit device limits each one of the movement paths of the displacement operating unit to be a straight line extending from the origin.

7. The multi-directional lock as claimed in claim 1 further including a reset device mounted between the displacement operating unit and the base seat and tend to move the displacement operating unit to an origin.

8. The multi-directional lock as claimed in claim 6, further including a reset device mounted between the displacement operating unit and the base seat and tend to move the displacement operating unit to the origin.

9. The multi-directional lock as claimed in claim 1, wherein the fixing unit is mounted on the displacement operating unit and comprises an insertion part, and the insertion part is configured to be inserted into the base seat to stop the displacement operating unit from moving toward any of the at least three buckles relative to the base seat.

10. The multi-directional lock as claimed in claim 8, wherein the fixing unit is mounted on the displacement operating unit and comprises an insertion part, and the insertion part is configured to be inserted into the base seat to stop the displacement operating unit from moving toward any of the at least three buckles relative to the base seat.

11. The multi-directional lock as claimed in claim 1, wherein the fixing unit includes at least one lock.

12. The multi-directional lock as claimed in claim 10, wherein the fixing unit includes at least one lock.

13. The multi-directional lock as claimed in claim 1 further including an anti-rotation device mounted between the displacement operating unit and the base seat and stopping the displacement operating unit from rotating relative to the base seat.

14. The multi-directional lock as claimed in claim 12 further including
an anti-rotation device mounted between the displacement operating unit and the base seat and stopping the displacement operating unit from rotating relative to the base seat.

15. The multi-directional lock as claimed in claim 1, wherein the at least three buckles are annularly spaced around the displacement operating unit.

16. The multi-directional lock as claimed in claim 14, wherein the at least three buckles are annularly spaced around the displacement operating unit.

17. Luggage including:
a luggage body comprising multiple opening parts;
a multi-directional lock as claimed in claim 1, wherein the at least three fastener assemblies respectively correspond to the multiple opening parts of the luggage body; after one of the at least three fastener assemblies is separated from the corresponding buckle, the corresponding opening part is openable.

18. A cabinet including:
multiple cabinet doors;
a multi-directional lock as claimed in claim 1, wherein the at least three fastener assemblies are respectively connected to the multiple cabinet doors; after one of the at least three fastener assemblies is separated from the corresponding buckle, the corresponding cabinet door is openable.
